(19) United States
(12) Patent Application Publication
(10) Pub. No.: US 2011/0309737 A1
(43) Pub. Date: Dec. 22, 2011

(54) ELECTRON-EMITTING DEVICE AND IMAGE DISPLAY APPARATUS USING THE SAME, AS WELL AS MANUFACTURING METHOD THEREFOR

(75) Inventors: Satoshi Tsutsui, Yokohama-shi (JP); Toshiharu Sumiya, Ebina-shi (JP); Takahiro Hachisu, Isehara-shi (JP)

(73) Assignee: CANON KABUSHIKI KAISHA, Tokyo (JP)

(21) Appl. No.: 13/114,424

(22) Filed: May 24, 2011

(30) Foreign Application Priority Data
Jun. 17, 2010 (JP) 2010-137888

(51) Int. Cl. H01J 1/304; H01J 9/34; H01J 1/00; H01J 9/02

(52) U.S. Cl. 313/310; 445/35; 445/24; 313/326

(57) ABSTRACT

The electron-emitting device is configured such that an inclination angle θ2 of a lower portion from a height-direction intermediate portion to the lower end is larger than the inclination angle θ1 of an upper portion from a lower edge of the concave portion to a height-direction intermediate portion. And, an electric resistance of a lower cathode portion which is a portion of the lower portion of the cathode is larger than that of an upper cathode portion which is a portion of the upper portion of the cathode.

### BACKGROUND OF THE INVENTION

1. Field of the Invention

The present invention relates to a field emission vertical electron-emitting device and an image display apparatus using the same, as well as a manufacturing method therefor.

2. Description of the Related Art

There have conventionally been disclosed an electron-emitting device and a manufacturing method therefor in Japanese Patent Application Laid-Open No. 2009-289762 as follows.

More specifically, according to Japanese Patent Application Laid-Open No. 2009-289762, the electron-emitting device includes an insulating step-shape forming member placed on a substrate and having an upper plane and a side plane; and a gate placed on the upper plane of the step-shape forming member. Further, a concave portion is formed so as to retract from a portion of the side plane of the step-shape forming member to just under the gate. Furthermore, the side plane of the step-shape forming member under the concave portion has a cathode having a protruding portion formed at an upper end of the cathode protruding in a direction from a lower edge toward an upper edge of the concave portion. The electron-emitting device is a field emission vertical electron-emitting device. When a voltage is applied to between the cathode and the gate, electrons can be field-emitted from the cathode side.

According to Japanese Patent Application Laid-Open No. 2009-289762, the electron-emitting device manufacturing method includes stacking a first insulating material, a second insulating material, and a first conductive material in that order on a substrate to form a resistor pattern, and then performing dry etching. This forms an insulating step-shape forming member (insulating member) having an upper plane on which a first conductive material layer is disposed and a side plane interposed between the upper plane and the substrate. Then, the resistor is separated and wet etching is performed to etch the second insulating layer constituting the step-shape forming member to form a concave portion so as to extract from a side plane of the step-shape forming member to just under the first conductive material layer. Subsequently, a second conductive material is deposited on the side plane from an inclined direction to form the cathode, while the gate is formed only with the first conductive material layer or together with the second conductive material layer stacked on the first conductive material layer to form the electron-emitting device according to the disclosure.

Further, Japanese Patent Application Laid-Open No. 2009-289762 discloses that as a result of the dry etching, the side plane of the step-shape forming member is inclined at about 80 degrees to the horizontal surface of the substrate and the second conductive material is deposited on the side plane at an incident angle of 40 or 20 degrees.

Meanwhile, the electron-emitting device is used, for example, as an image display apparatus. With an increase in the number of devices due to a large size and a high definition of the image display apparatus, the intensity difference between devices is required to be reduced. In order to prevent destruction or deterioration of a device causing an intensity difference, it is necessary to suppress current from flowing through the device when an excessive current or current fluctuation occurs. For this purpose, U.S. Pat. No. 5,838,103 discloses a method of suppressing current from flowing through the device when an excessive current or current fluctuation occurs by providing a current limiting resistance layer (ballast resistance layer) separately from the component member of the electron-emitting device.

Meanwhile, the electron-emitting device is required to further increase electron emission efficiency so as to configure an image display apparatus having excellent intensity with less power consumption. This is also applied to the field emission vertical electron-emitting device disclosed in Japanese Patent Application Laid-Open No. 2009-289762.

In addition, as disclosed in U.S. Pat. No. 5,838,103, the configuring of providing a current limiting resistance layer separately from the component member of the electron-emitting device requires increasing the electron-emitting device installation area, which unfortunately complicates the manufacturing process.

### SUMMARY OF THE INVENTION

An object of the present invention is to provide a field emission vertical electron-emitting device having a unit for not only increasing electron emission efficiency but also suppressing current from flowing through the device when an excessive current or current fluctuation occurs. Another object of the present invention is to provide an image display apparatus using the electron-emitting device, as well as a method of manufacturing the electron-emitting device and the image forming device in a simple and efficient manner.

According to a first aspect of the present invention, an electron-emitting device comprises: a step-shape forming member having upper and side planes and placed on a substrate; a gate placed on the upper plane of the step-shape forming member; a concave portion formed at the side plane of the step-shape forming member just under the gate; and a cathode placed on the side plane of on the step-shape forming member and having an upper edge at which a protruding portion is formed to protrude in a direction from a lower edge toward the upper edge, wherein an inclination angle of an upper portion of the side plane of the step-shape forming member formed from a lower edge of the concave portion to a middle portion in height direction of the step-shape forming member is not larger than an inclination angle of a lower portion of the side plane of the step-shape forming member formed from the middle portion to a lower end portion of the step-shape forming member, and an electric resistance of an upper portion of the cathode along the upper portion of the side plane is not larger than an electric resistance of a lower portion of the cathode along the lower portion of the side plane.

According to a second aspect of the present invention, an image display apparatus comprises: a rear plate on which the cathode of the electron-emitting device according to the first aspect is connected through the lower portion of the cathode to a wiring; and a face plate having an anode disposed in opposition to the protruding portion of the cathode sandwiching the gate between the face plate and the cathode, and a light emitting member emitting a light responsive to an irradiation with an electron, wherein the rear plate and face plate are arranged in opposition to each other forming a gap therebetween.

According to third and fourth aspects of the present invention, a method of manufacturing an image display apparatus comprises steps of: etching a stacked layer structure formed by successively stacking, on a substrate, a first insulating material, a second insulating material and a first electroconductive material, to form a step-shape forming member having upper and side planes and having at the upper plane a layer of the first electroconductive material; further etching a layer of the second insulating material to form a concave portion at the side plane of the step-shape forming member just under the layer of the first electroconductive material; and thereafter, bonding a second electroconductive material to form a cathode placed on the side plane of on the step-shape forming member and having an upper edge at which a protruding portion is formed to protrude in a direction from a lower edge toward the upper edge, and to form a gate including the layer of the first electroconductive material alone or including the layer of the first electroconductive material and the layer of the second electroconductive material stacked on the layer of the first electroconductive material.

According to the third aspect of the present invention, the method further comprises step of: forming, at a plurality times, the layer of the first insulating material, and, during the step of etching the stacked layer structure, an etching rate is set such that an etching rate of the lower portion of the layer of the first insulation material is smaller than an etching rate of the upper portion of the layer of the first insulation material, such that an inclination angle of an upper portion of the side plane of the step-shape forming member formed from a lower edge of the concave portion to a middle portion in height direction of the step-shape forming member is not larger than an inclination angle of a lower portion of the side plane of the step-shape forming member formed from the middle portion to a lower end portion of the step-shape forming member, and the second electroconductive material is supplied from a direction perpendicular to a surface of the substrate to be deposited thereon.

According to the fourth aspect of the present invention, the step of etching the stacked layer structure is performed in a plurality of times in a different conditions, such that an inclination angle of an upper portion of the side plane of the step-shape forming member formed from a lower edge of the concave portion to a middle portion in height direction of the step-shape forming member is not larger than an inclination angle of a lower portion of the side plane of the step-shape forming member formed from the middle portion to a lower end portion of the step-shape forming member, and the second electroconductive material is supplied from a direction perpendicular to a surface of the substrate to be deposited thereon.

According to a fifth aspect of the present invention, provided is a method of manufacturing an image display apparatus comprising steps of: preparing a rear plate on which the cathode of the electron-emitting device according to the third or fourth aspect is connected through the lower portion of the cathode to a wiring; preparing a face plate having an anode disposed in opposition to the protruding portion of the cathode sandwiching the gate between the face plate and the cathode, and a light emitting member emitting a light responsive to an irradiation with an electron; and arranging the rear plate and face plate are arranged in opposition to each other to form a gap therebetween.

The cathode in the electron-emitting device according to the first aspect of the present invention is configured such that the lower cathode portion located in the lower portion on the side plane of the step-shape forming member has a higher electric resistance than that of the upper cathode portion located in the upper portion thereon. When the cathode is connected to a drive circuit through the lower cathode portion having a large electric resistance, the lower cathode portion serves as a current limiting resistance layer, which can suppress current from flowing through the device when an excessive current or current fluctuation occurs. In addition, since the lower cathode portion is a part of the cathode, namely, a part of the component member of the electron-emitting device, this configuration can prevent an increase in electron-emitting device installation area and complicated manufacturing process in comparison with the configuring of providing the current limiting resistance layer as a separate member. Further, as is understood from an embodiment described later, the inclined plane of the upper portion of the side plane has a smaller inclination angle than that of the lower portion of the side plane, which can increase the electron emission efficiency.

The image display apparatus according to a second aspect of the present invention uses the electron-emitting device according to the first aspect of the present invention and the cathode of the electron-emitting device is connected to a wiring through the lower cathode portion. Accordingly, the lower cathode portion serves as a current limiting resistance layer, which can suppress current from flowing through the device when an excessive current or current fluctuation occurs and can provide excellent image display with a small intensity difference between devices. Further, the excellent electron emission efficiency of the electron-emitting device can reduce power consumption.

According to the electron-emitting device manufacturing method according to the third and fourth aspects of the present invention, at the time of etching for forming the step-shape forming member having the first conductive material layer on the upper plane, the lower portion of the side plane of the formed step-shape forming member can have a larger inclination angle than the inclination angle of the upper portion of the side plane thereof. Accordingly, supplying and depositing of the second conductive material for forming the cathode from a direction perpendicular to the substrate surface can cause a difference in electric resistance between the upper cathode portion and the lower cathode portion. More specifically, the lower portion of the side plane has a larger inclination than that of the upper portion of the side plane in a direction of applying the second conductive material. Accordingly, the lower portion has a lower deposit density of the second conductive material and has a higher electric resistance than the upper portion. Thus, the electron-emitting device according to the first aspect of the present invention can be easily manufactured. In other word, the electron-emitting device according to the first aspect of the present invention can be an easy-to-manufacture device.

According to the method of manufacturing the image display apparatus according to the fifth aspect of the present invention, the image display apparatus having aforementioned advantages can be easily manufactured.

Further features of the present invention will become apparent from the following description of exemplary embodiments with reference to the attached drawings.

### BRIEF DESCRIPTION OF THE DRAWINGS

FIGS. 1A, 1B and 1C are schematic cross sections illustrating an example of an electron-emitting device according to the present invention.

FIG. 2 is a graph illustrating a relation between an inclination angle of a side plane of a step-shape forming member and a resistance of a cathode formed thereon.

FIG. 3 is an explanatory drawing describing that the electron-emitting device according to the present invention is driven.

FIG. 4 is a schematic partial cross sectional perspective view illustrating an example of the image display apparatus of the present invention.

FIGS. 5A, 5B, 5C, 5D, 5E, 5F and 5G are drawings illustrating an example of the steps of manufacturing the electron-emitting device according to the present invention.

FIGS. 6A, 6B, 6C, 6D, 6E, 6F and 6G are drawings illustrating another example of the steps of manufacturing the electron-emitting device according to the present invention.

FIG. 7 is a schematic cross sectional view of an electron-emitting device according to a comparative example of the present invention.

### DESCRIPTION OF THE EMBODIMENTS

Preferred embodiments of the present invention will now be described in detail in accordance with the accompanying drawings.

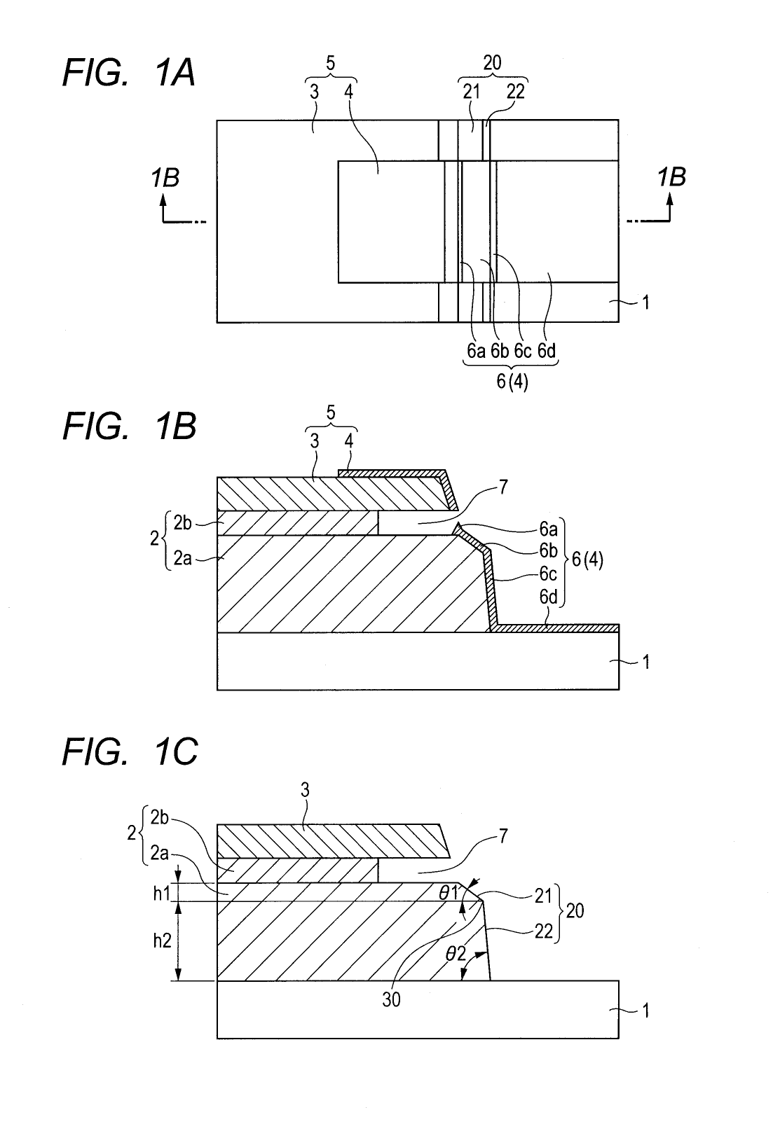

First, an electron-emitting device according to the present invention will be described. FIGS. 1A to 1C illustrate an example of the electron-emitting device according to the present invention. FIG. 1A is a schematic plan view. FIG. 1B is a schematic cross sectional view along line 1B-1B in FIG. 1A. FIG. 1C is a schematic cross sectional view along line 1B-1B in FIG. 1A illustrating a state in which the second conductive material layer is removed.

In FIGS. 1A to 1C, the electron-emitting device according to the present invention includes a substrate 1, an insulating step-shape forming member 2, a first insulating material layer 2a, a second insulating material layer 2b, a first conductive material layer 3, a second conductive material layer 4, a gate 5, a cathode 6, and a concave portion 7.

The step-shape forming member 2 is formed into a shape having an upper plane and a side plane 20 such as a line shape or the like and is protrudingly provided on the substrate 1 having a structure in which the first insulating material layer 2a and the second insulating material layer 2b are stacked in that order on the substrate 1. The first conductive material layer 3 is provided on the upper plane of the step-shape forming member 2. According to the present embodiment, the second conductive material layer 4 is further overlappingly provided on the first conductive material layer 3. The first conductive material layer 3 and the second conductive material layer 4 integrally constitute the gate 5. The concave portion 7 is formed so as to retract from a portion of the side plane 20 of the step-shape forming member 2 to just under the gate 5. As described later, the concave portion 7 is formed by removing by etching the second insulating material layer 2b from the side plane 20 side of the step-shape forming member 2. Further, the side plane of the step-shape forming member 2 has the cathode 6 made of the second conductive material layer. An upper end of the cathode 6 has a protruding portion 6a protruding in a direction from a lower edge of the concave portion 7 toward an upper edge of the concave portion 7. The protruding portion 6a faces an end portion of the gate 5 on the side plane 20 side of the step-shape forming member 2. Note that the side plane 20 of the step-shape forming member 2 refers to a side plane to which the cathode 6 is to be attached.

In particular, as illustrated in FIG. 1C, the side plane 20 of the step-shape forming member 2 is formed such that the inclination angle θ1 of a surface parallel to the substrate 1 to an upper side plane portion 21 extending from the lower edge of the concave portion 7 to a height-direction intermediate portion 30 is different from the inclination angle θ2 of the substrate 1 to a lower side plane portion 22 extending from the height-direction intermediate portion 30 to the lower end of the side plane 20. In other word, the side plane 20 has two continuously inclined planes each with a different inclination. In addition, the inclination angle θ1 of the upper side plane portion 21 refers to a crossing angle between a surface of the substrate 1 and an inclined plane of the upper side plane portion 21. The inclination angle θ2 of the lower side plane portion 22 refers to a crossing angle between a surface of the substrate 1 and an inclined plane of the lower side plane portion 22. According to the present invention, the inclination angle θ1 of the upper side plane portion 21 and the inclination angle θ2 of the lower side plane portion 22 satisfy the relation θ1<θ2. Note that the inclination angles θ1 and θ2 are values measured by a scanning electron microscope (SEM).

The cathode 6 has an upper cathode portion 6b located in the upper side plane portion 21 of the side plane 20 of the step-shape forming member 2 and a lower cathode portion 6c located in the lower side plane portion 22. In addition, the cathode 6 according to the present embodiment also has an on-substrate cathode portion 6d continuously extending from the lower cathode portion 6c to the surface of the substrate 1. According to the present invention, the lower cathode portion 6c has a higher electric resistance than the upper cathode portion 6b. The lower cathode portion 6c serves as a current limiting resistance layer for suppressing current from flowing through the device when an excessive current or current fluctuation occurs. The lower cathode portion 6c being a part of the cathode 6 can eliminates the disadvantageous need to provide a current limiting resistance layer as a separate member. In order to cause the lower cathode portion 6c to serve as a current limiting resistance layer, the lower cathode portion 6c preferably has a higher electric resistance than the upper cathode portion 6b. The electric resistance of the lower cathode portion 6c is preferably 15 times or higher than the electric resistance of the upper cathode portion 6b. In addition, according to the present invention, since the inclination angle θ1 of the upper side plane portion 21 is smaller and less steeply inclined than the inclination angle θ2 of the lower side plane portion 22, the configuration can improve electron emission efficiency more than the configuration in which the entire side plane 20 of the step-shape forming member 2 is inclined at an inclination angle of θ2.

Further more specifically, in the image display apparatus having the electron-emitting device, when an excessive current or current fluctuation occurs, an electric short or leak may occur between the gate 5 and the cathode 6, which leads to a sharp temporal increase in current, and may cause an emitter in the surrounding area to be broken. As a result, the image display apparatus suffers from a large number of line faults, point faults, and further insulation breakdowns. This requires a resistance layer capable of suppressing current fluctuations against an excessive current.

The present invention can provide a high resistance portion in the electron-emitting device without providing a current limiting resistance layer as a separate structure. Thus, current can be suppressed even if an excessive current occurs. More specifically, according to an example of the electron-emitting device of the present invention illustrated in FIGS. 1A to 1C, the side plane 20 of the step-shape forming member 2 has the upper side plane portion 21 with a height of h1 and an inclination angle of θ1; and the lower side plane portion 22 with a height of h2 and an inclination angle of θ2. The angles θ1 and θ2 have the relation θ1<θ2. The angle θ2 is preferably in a range from 70 to 90 degrees, and more preferably in a range from 80 to 90 degrees. The angle θ2 is preferably 10 degrees or more higher than the angle θ1, and more preferably 20 degrees or higher than the angle θ1.

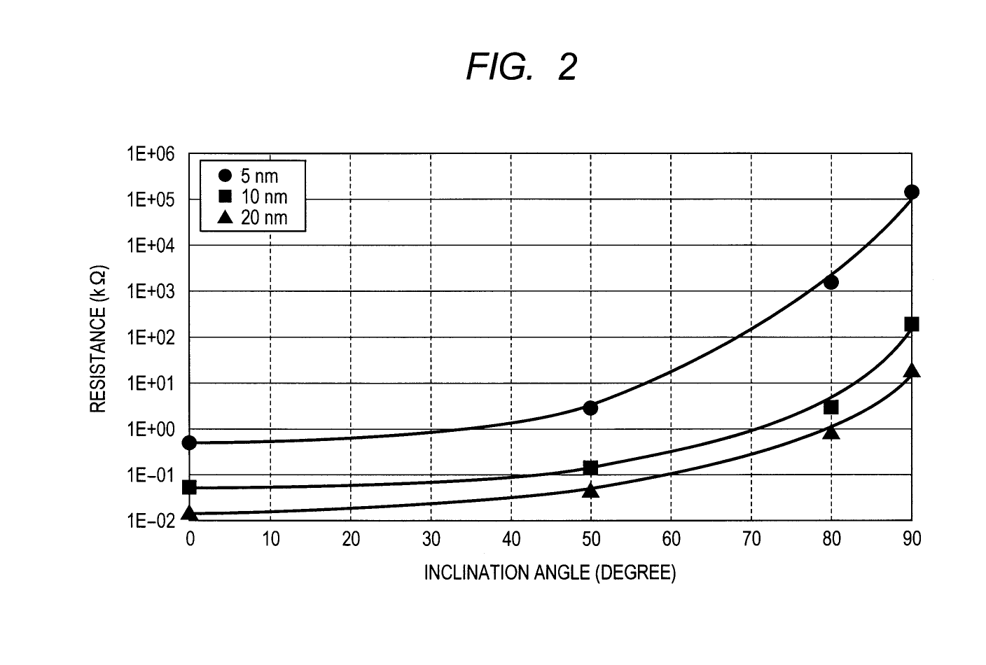

As will be described in the manufacturing method, the electron-emitting device according to the present invention can be manufactured in such a manner that in the state of FIG. 1C, a second conductive material is supplied from a direction perpendicular to the surface of the substrate 1, and as illustrated in FIGS. 1A and 1B, the cathode 6 is formed by the second conductive material layer 4 deposited on the side plane 20 of the step-shape forming member 2. The lower cathode portion 6c formed in the lower side plane portion 22 with a small inclination to the direction of supplying the second conductive material has a small density of the second conductive material. On the contrary, the upper cathode portion 6b formed in the upper side plane portion 21 with a large inclination to the direction of supplying the second conductive material has a large density of the second conductive material. For that reason, the resistance of the cathode 6 is correlated with the inclination angles θ1 and θ2 of the place in which the cathode 6 is formed and is proportional to the length of the place (distance in the vertical direction along the inclined plane). The lower cathode portion 6c located in the lower side plane portion 22 is steeply inclined at an inclination angle of θ2, and thus has a coarse film quality and a high resistance, and thus can be used as a current limiting resistance. Note that the height h1 of the upper side plane portion 21 and the height h2 of the lower side plane portion 22 preferably have the relation h1<h2 from the point of view of increasing the resistance of the lower cathode portion 6c, and h1 is preferably one half or less of the h2, and more specifically, is preferably 20 to 50 nm. Note that FIG. 2 illustrates the relation between the inclination angle (inclined plane angle) and the resistance of the cathode 6, assuming that the side plane 20 of the step-shape forming member 2 has a uniform inclination angle and the cathode 6 is formed by Mo films (with three thicknesses: 5 nm, 10 nm, and 20 nm).

According to the electron-emitting device of the present invention, the inclination angle θ1 of the upper side plane portion 21 of the side plane 20 of the step-shape forming member 2 is smaller than the inclination angle θ2 of the lower side plane portion 22. Accordingly, the second conductive material deposited on the upper portion has a higher density than that of the lower portion. Thus, this structure can form the upper cathode portion 6b more stably than the structure in which the entire side plane 20 is formed at an inclination angle of θ2, and is advantageous from the point of view of obtaining excellent electron-emitting characteristics of the electron-emitting device. Note that the protruding portion 6a located at the front end of the cathode 6 is preferably formed across the lower surface of the concave portion 7 and the upper side plane portion 21.

Available examples of the substrate 1 include an insulating plate made of a silica glass, a glass containing less amount of an impurity such as Na, a blue plate glass, a stacked layer structure in which SiO₂ is stacked on a blue plate glass or an Si substrate by a sputtering technique or the like, and ceramic such as alumina.

Available materials of the first insulating material layer 2a and the second insulating material layer 2b include oxides such as SiO₂ and nitrides such as Si₃N₄, and a material highly resistant to a high electric field is selected. Note that the selectively etchable material of the second insulating material layer 2b is appropriately selected with respect to the first insulating material layer 2a. For example, when the first insulating material layer 2a is made of an insulating material such as Si₃N₄, the second insulating material layer 2b is made of an insulating material such as SiO₂.

Examples of materials forming the first conductive material layer 3 include a metal or alloy material such as Be, Mg, Ti, Zr, Hf, V, Nb, Ta, Mo, W, Al, Cu, Ni, Cr, Au, Pt, and Pd; and a carbide such as TiC, ZrC, HfC, TaC, SiC, and WC. Further included are a boride such as HfB₂, ZrB₂, CeB₆, YB₄, and GbB₄; a nitride such as TaN, TiN, ZrN, and HfN; and a semiconductor such as Si and Ge. Furthermore included are an organic polymeric material, an amorphous carbon, a graphite, a diamond-like carbon, and a diamond-dispersed carbon and carbon compound. Examples of materials forming the second conductive material layer 4 include a metal such as Mo, Pt, Ru, Ag, Au, Ti, In, Cu, Cr, Fe, Zn, Sn, Ta, W, and Pd; and a material with a low work function such as carbon and HfC. The gate 5 according to the present embodiment is formed in such a manner that the second conductive material layer 4 is overlapped on the first conductive material layer 3, and both the second conductive material layer 4 and the first conductive material layer 3 integrally constitute the gate 5. Alternatively, the gate 5 may be formed of only the first conductive material layer depending on the material of the first conductive material layer 3. Note that in order to obtain an excellent electron emission efficiency, as described in the present embodiment, the gate 5 may preferably have a structure in which the second conductive material layer 4 is overlapped on the first conductive material layer 3.

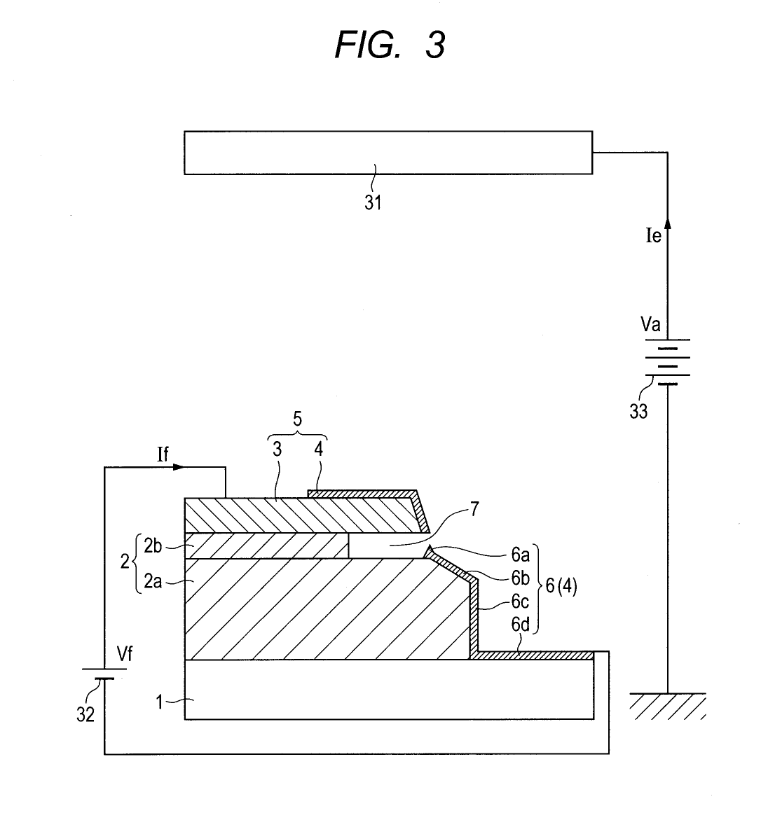

By referring to FIG. 3, driving of the electron-emitting device of FIGS. 1A to 1C will be described. In FIG. 3, the electron-emitting device includes an anode 31, a power source 32 for driving the electron-emitting device, and a high voltage power supply 33 for applying a voltage to the anode 31. Note that the same reference numeral or character is assigned to the same component as that in FIGS. 1A to 1C. When the electron-emitting device is driven, the driving power source 32 applies a drive voltage Vf between the gate 5 and the cathode 6. A high voltage is applied to the gate 5, and a low voltage is applied to the cathode 6. Further, the high voltage power supply 33 applies an anode voltage Va to the anode 31 to accelerate electrons emitted from the protruding portion 6a of the cathode 6 toward the anode 31. Thus, the anode 31 is arranged facing the protruding portion 6a of the cathode 6 through the gate 5. This arrangement allows electrons to be efficiently emitted from the cathode 6. Note that reference character If denotes a device current, and reference character Ie denotes an emission current. A light emitting member which emits light by electron irradiation is stacked on the anode 31, and then an image can be displayed by causing the light emitting member to emit light.

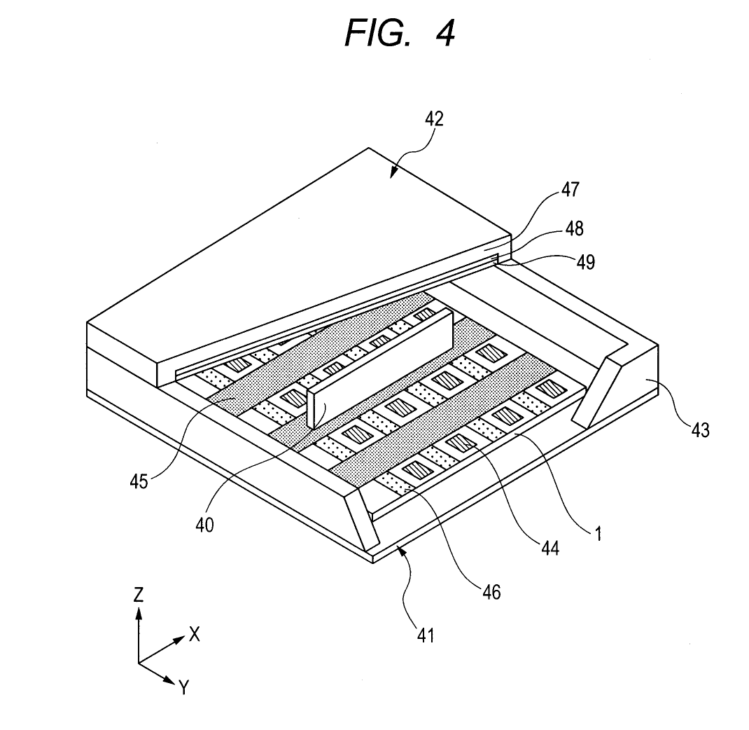

Now, by referring to FIG. 4, the image display apparatus of the present invention will be described.

The image display apparatus of the present invention uses the electron-emitting device of the present invention described in FIGS. 1A to 1C. In FIG. 4, the image display apparatus includes a rear plate 41, a face plate 42, and a frame body 43. The surface of the rear plate 41 holds the substrate 1 having a plurality of electron-emitting devices 44 thereon as described in FIGS. 1A to 1C. Although not illustrated in FIG. 4, each electron-emitting device 44 includes the step-shape forming member 2, the gate 5, the cathode 6, and the like as illustrated in FIGS. 1A to 1C. Further, the surface of the substrate 1 also includes an X-direction wiring 45 for mutually connecting the cathodes 6 (see FIGS. 1A to 1C) of the plurality of electron-emitting devices 44; and a Y-direction wiring 46 for mutually connecting the gates 5. Each cathode 6 is connected to the X-direction wiring 45 through the lower cathode portion 6c described in FIGS. 1A to 1C. The face plate 42 includes a light-transmitting glass substrate 47, a plurality of light emitting members (phosphor) 48 disposed on the glass substrate 47, and an anode 49 stacked on the light emitting member 48. The light emitting member 48 emits light in response to irradiation of electrons emitted from the electron-emitting device 44. The rear plate 41 and the face plate 42 are arranged facing each other with a gap therebetween in such a manner that the mounting surface of the electron-emitting device 44 and the like faces the mounting surface of the anode 49 and the like and the frame body 43 is interposed around and between both the mounting surfaces. The inside of the space surrounded and sealed by the rear plate 41, the face plate 42, and the frame body 43 is evacuated to vacuum and constitutes the image display apparatus. In order to meet the demand for a larger size image display apparatus, a spacer 40 which is an atmospheric-pressure-resistant support structure may be interposed between the rear plate 41 and the face plate 42. When the image display apparatus is driven, a scan signal is input to the X-direction wiring 45, and an information signal is input to the Y-direction wiring 46. At the same time, a high voltage is applied to the anode 49 to accelerate the electrons emitted from the electron-emitting device 44 toward the anode 49 and to irradiate the light emitting member 48 with the accelerated electrons. Thus, an image can be displayed by selectively activating a desired light emitting member 48 to emit light.

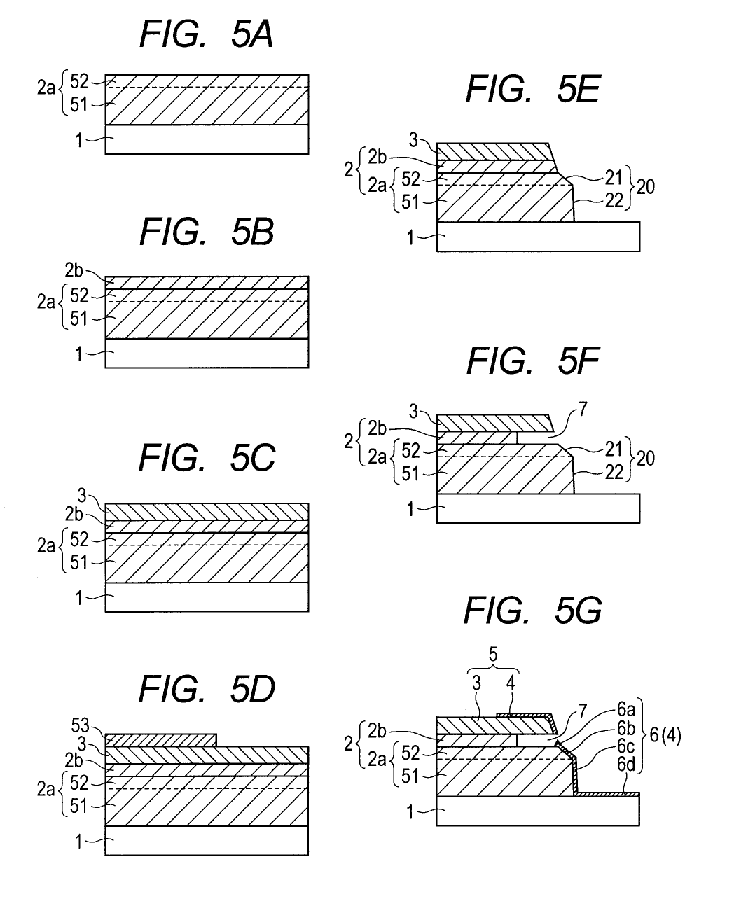

Now, by referring to FIGS. 5A to 5G, an example of the electron-emitting device manufacturing method of the present invention will be described.

The first insulating material layer 2a is formed by film formation a plurality of times on the substrate 1, the surface of which is sufficiently cleaned in advance, by a general vacuum film formation technique such as a sputtering technique, a CVD technique, or a vacuum deposition technique (see FIG. 5A). In this case, each film is deposited under a film formation condition for ensuring a mutually different etching rate at a subsequent etching step. Specifically, each film layer is stacked by changing the film formation condition so as to ensure that the lower portion of the first insulating material layer 2a has a lower etching rate than the upper portion thereof. In the figure, reference numeral 51 denotes a first layer which is deposited at the first time, and reference numeral 52 denotes a second layer which is deposited at the second time.

Following the first insulating material layer 2a, the second insulating material layer 2b is formed by a general vacuum film formation technique such as a sputtering technique, a CVD technique, or a vacuum deposition technique (see FIG. 5B). The film formation is performed just once.

Following the second insulating material layer 2b, the first conductive material layer 3 is deposited. The first conductive material layer 3 can be formed by a vacuum deposition technique or a general vacuum film formation technique such as a sputtering technique (see FIG. 5C).

Then, a resistor pattern 53 is formed on a desired portion with photolithography by applying a photo resist by spin coating and mask pattern exposure and development (see FIG. 5D).

Then, a part of the stacked layer structure including the first insulating material layer 2a, the second insulating material layer 2b, and the first conductive material layer 3 is removed by etching to form the insulating step-shape forming member 2 having an upper plane and the side plane 20, and the first conductive material layer 3 formed on the upper plane. Specifically, the present step refers to a step of removing a part of the stacked layer structure including the first insulating material layer 2a, the second insulating material layer 2b, and the first conductive material layer 3 by wet etching or dry etching. In the etching step, a smooth etching surface is desirable. An appropriate etching method may be selected according to each material. For example, when Si₃N₄ is selected as the first insulating material layer 2a, SiO₂ is selected as the second insulating material layer 2b, TaN is selected as the first conductive material layer 3, and the first insulating material layer 2a is deposited twice or more under each different film formation condition, dry etching may be performed using CF₄, Ar, and SF₆ gasses. In this case, a difference in film quality inside the first insulating material layer 2a allows the upper side plane portion 21 and the lower side plane portion 22 each having a different inclination to the surface of the substrate 1 to be formed on the side plane of the first insulating material layer 2a (see FIG. 5E).

Then, the concave portion 7 is formed by wet etching or the like so as to retract from the side plane 20 of the step-shape forming member 2 to just under the first conductive material layer 3. As the etching method, for example, when TaN is selected as the first conductive material layer 3, Si₃N₄ is selected as the first insulating material layer 2a, and SiO₂ is selected as the second insulating material layer 2b, buffered hydrofluoric acid is used as the etchant for etching. Thus, the second insulating material layer 2b is selectively etched, and only the second insulating material layer 2b is retracted from the side plane 20 side of the step-shape forming member 2 to form the concave portion 7 having an opening at the side plane 20 (see FIG. 5F).

After the concave portion 7 is formed, the second conductive material is deposited at least on the side plane 20 of the step-shape forming member 2 to form the cathode 6 by means of the second conductive material layer 4. The second conductive material is supplied from a direction perpendicular to the surface of the substrate 1. Thus, the cathode 6 having the aforementioned protruding portion 6a, the upper cathode portion 6b, and the lower cathode portion 6c can be formed (see FIG. 5G). The film formation of the second conductive material layer 4 can be performed by a vacuum deposition technique, a sputtering technique, and the like. At this time, the second conductive material layer 4 is also stacked on the first conductive layer 3 of the upper plane of the step-shape forming member 2. The second conductive material layer 4 on the first conductive layer 3 may be formed in such a manner that a separation layer is preliminarily formed on the first conductive layer 3 and then is separated and removed therefrom.

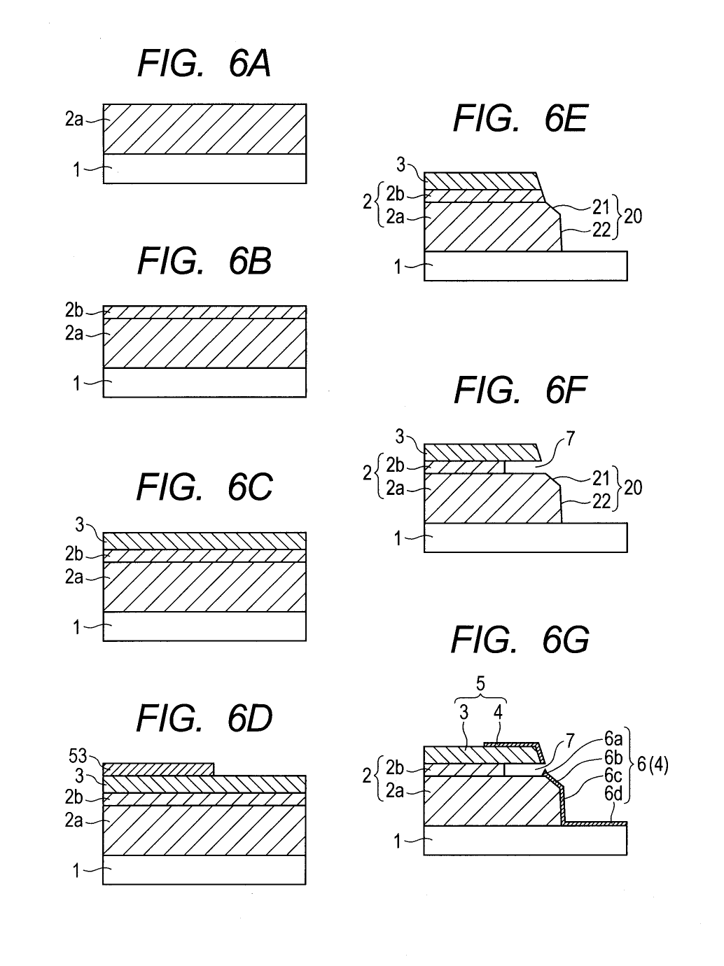

Now, by referring to FIGS. 6A to 6G, another example of the electron-emitting device manufacturing method of the present invention will be described.

The first insulating material layer 2a is formed by one film formation on the substrate 1, the surface of which is sufficiently cleaned in advance, by a general vacuum film formation technique such as a sputtering technique, a CVD technique, or a vacuum deposition technique (see FIG. 6A).

Then, following the first insulating material layer 2a, the second insulating material layer 2b is formed by a general vacuum film formation technique such as a sputtering technique, a CVD technique, or a vacuum deposition technique (see FIG. 6B).

Further, following formation of the second insulating material layer 2b, the first conductive material layer 3 is deposited. The first conductive material layer can be formed by a vacuum deposition technique or a general vacuum film formation technique such as a sputtering technique (see FIG. 6C).

Then, a resistor pattern 53 is formed on a desired portion with photolithography by applying a photo resist by spin coating and mask pattern exposure and development (see FIG. 6D).

Then, a part of the stacked layer structure including the first insulating material layer 2a, the second insulating material layer 2b, and the first conductive material layer 3 is removed by etching to form the insulating step-shape forming member 2 having an upper plane and a side plane 20, and the first conductive material layer 3 formed on the upper plane. The etching is performed under a plurality of conditions such that the inclination angle of the lower side plane portion 22 is larger than the inclination angle of the upper side plane portion 21 on the side plane 20 of the step-shape forming member 2. For example, dry etching may be performed up to a middle of the first insulating material layer 2a using CF₄, Ar, and SF₆ gases as the etching gas; and dry etching may be performed on the remaining portion using CF₄, and Ar gases. In this case, from the difference in gas flow rate during dry etching, the upper side plane portion 21 and the lower side plane portion 22 each having a different inclination to the surface of the substrate 1 can be formed on the side plane of the first insulating material layer 2a (see FIG. 6E).

Then, the concave portion 7 is formed in the same manner as described in FIG. 5F, and further the cathode 6 is formed in the same manner as described in FIG. 5G (see FIGS. 6F and 6G).

Now, by referring to FIGS. 4 and 1A to 1C, the method of manufacturing the image display apparatus of the present invention will be described. The rear plate 41 is formed on which the cathode 6 of the electron-emitting device manufactured in the aforementioned manner is connected to the wiring through the lower cathode portion 6c which is a portion of the lower side plane portion 22 of the cathode 6. Further, the face plate 42 having the light emitting member 48 which emits light by irradiation of the anode 49 and electrons is formed. Both the rear plate 41 and the face plate 42 are arranged facing each other with a gap therebetween and with the frame body 43 sandwiched therebetween, and the inside of the space is evacuated to vacuum and thereby the image display apparatus can be manufactured.

### Examples 1 to 3

The electron-emitting device configured as illustrated in FIGS. 1A to 1C was manufactured. Then, the electron-emitting device was connected to the power supply and was driven facing the anode 31 as illustrated in FIG. 3. The electron-emitting device was manufactured according to the procedure illustrated in FIGS. 5A to 5G.

(Step 1)

A blue plate glass was used as the substrate 1 and was sufficiently cleaned. Then, by means of the CVD technique, the first insulating material layer 2a was formed by depositing an Si₃N₄ film with a thickness of 150 nm twice each time with a different amount of supply of SiH₄ (see FIG. 5A). In any case, the thickness of the first layer 51 which is a lower layer of the first insulating material layer 2a was 100 nm and the thickness of the second layer 52 which is an upper layer thereof was 50 nm. Table 1 shows the amount of supply of SiH₄ at the time of forming the first layer 51 and at the time of forming the second layer 52.

TABLE 1

Amount of supply of SiH₄ (sccm)

| | At forming first layer | At forming second layer |
|---|---|---|
| Example 1 | 2500 | 2688 |
| Example 2 | 2500 | 2875 |
| Example 3 | 2500 | 3250 |

(Step 2)

Then, by means of the sputtering technique, an SiO₂ film with a thickness of 25 nm is deposited to form the second insulating material layer 2b, and an TaN film with a thickness of 40 nm is deposited to form the first conductive material layer 3 in that order (see FIGS. 5B and 5C).

(Step 3)

Then, in the photolithography step, a positive photo resist is spin-coated and exposed and developed using a photo mask pattern to form a resistor pattern 53 (see FIG. 5D).

(Step 4)

Subsequently, the patterned resistor pattern 53 was used as a mask to dry etch the first insulating material layer 2a, the second insulating material layer 2b, and the first conductive material layer 3 using each of the CF₄, Ar, and SF₆ gases (see FIG. 5E). The flow rate of the etching gases was CF₄/Ar/SF₆=800 sccm/800 sccm/100 sccm in any of the examples 1 and 2, and a comparative example 1. As a result, from the difference in film quality inside the first insulating material layer 2a, the two inclinations each with a different angle were formed on the side plane of the step-shape forming member 2 which is the side plane of the first insulating material layer 2a. The sectional shapes were confirmed and measured by a scanning electron microscope. The inclination angle θ1 of the upper side plane portion 21 and the inclination angle θ2 of the lower side plane portion 22 were shown in Table 2.

(Step 5)

Buffered hydrofluoric acid was used as the etching solution to selectively etch the second insulating material layer 2b for seven minutes. Thus, the second insulating material layer 2b is retracted about 100 nm from the side plane 20 of the step-shape forming member 2 to form the concave portion 7 (see FIG. 5F).

(Step 6)

Then, Mo was selectively deposited on the side plane 20 with a thickness of 10 nm from a direction perpendicular to the surface of the substrate 1 to form the cathode 6 with a width of 200 μm. At the same time, Mo was also deposited on the first conductive material layer 3 of the upper plane of the step-shape forming member 2. Thus, the TaN layer which is the first conductive material layer 3 and Mo which is the second conductive material layer 4 were integrally formed into the gate 5.

Regarding the electron-emitting device manufactured in the above manner, the Mo density and the resistance value of the lower cathode portion 6c, the Mo density and the resistance value of the upper cathode portion 6b, the electron emission efficiency ratio, the discharge resistant performance, and the resistance ratio were measured. In general, an XRR (X-ray reflectance method) is used to measure the Mo density (film density), but it may be difficult to measure the Mo density of an actual electron-emitting device. In that case, for example, the following method may be used as the film density measuring method. More specifically, a high resolution electron energy loss spectroscopy electron microscope combining a TEM (transmission electron microscope) and an EELS (electron energy loss spectroscopy) is used to perform quantitative analysis on an element. Then, in comparison with a film whose density is known, a calibration curve is generated. Thus, the density can be calculated. In the present examples, the Mo density was measured by a measurement method using the high resolution electron energy loss spectroscopy electron microscope. The resistance ratio was calculated by (resistance value of lower cathode portion)/(resistance value of upper cathode portion). The resistance ratio together with the inclination angle θ1 of the upper side plane portion 21 and the inclination angle θ2 of the lower side plane portion 22 are shown in Table 2. Note that the emission efficiency ratio is a ratio assuming the electron emission efficiency of a comparative example 1 (described later) as 1. The method of evaluating the discharge resistant performance was such that a pulse intentionally inducing discharge (hereinafter referred to as “discharge inducing pulse”) was superimposed on a drive voltage Vf applied between the cathode and the gate of the electron-emitting device, and a check was made to see whether the electron-emitting device is broken or not. The discharge inducing pulse was a rectangular pulse with a width of 100 nsec and a peak voltage of 0.5 times the drive voltage. The discharge inducing pulse was superimposed on the drive voltage and the electron-emitting device was driven at 60 Hz for 10 hours. If the electron-emitting device was not broken, the electron-emitting device was evaluated as “◯”, and if broken, the electron-emitting device was evaluated as “x”. The resistance ratio was calculated by (resistance ratio)=(resistance value of lower cathode portion)/(resistance value of upper cathode portion).

TABLE 2

| | Inclination | | Mo density | | Resistance | | | | |
|---|---|---|---|---|---|---|---|---|---|
| | angle (degrees) | | (g/cm³) | | value (kΩ) | | Emission | Discharge | |
| | Lower | Upper | Lower | Upper | Lower | Upper | efficiency | resistant | Resistance |
| | portion | portion | portion | portion | portion | portion | ratio | performance | ratio |
| Example | 90 | 85 | 6.15 | 6.75 | 133.3 | 13.33 | 1.1 | ∘ | 10 |
| 1 | | | | | | | | | |
| Example | 90 | 80 | 6.15 | 6.9 | 133.3 | 2.667 | 1.4 | ∘ | 50 |
| 2 | | | | | | | | | |
| Example | 90 | 70 | 6.15 | 7.5 | 133.3 | 0.333 | 1.7 | ∘ | 400 |
| 3 | | | | | | | | | |

### Examples 4 to 6

In the examples 4 to 6, the electron-emitting device was manufactured in the same manner as in the examples 1 to 3 except that the amount of supply of SiH₄ at the time of forming the first layer 51 and at the time of forming the second layer 52 in step 1 is as shown in Table 3, and the same items were measured. The measured results were shown in Table 4. Note that the emission efficiency ratio is a ratio assuming the electron emission efficiency of a comparative example 1 (described later) as 1.

TABLE 3

Amount of supply of SiH₄ (sccm)

| | At forming first | At forming second |
|---|---|---|
| | layer | layer |
| Example 4 | 2688 | 2875 |
| Example 5 | 2688 | 3063 |
| Example 6 | 2688 | 3250 |

TABLE 4

| | Inclination | | Mo density | | Resistance | | | | |
|---|---|---|---|---|---|---|---|---|---|
| | angle (degrees) | | (g/cm³) | | value (kΩ) | | Emission | Discharge | |
| | Lower | Upper | Lower | Upper | Lower | Upper | efficiency | resistant | Resistance |
| | portion | portion | portion | portion | portion | portion | ratio | performance | ratio |
| Example | 85 | 80 | 6.75 | 6.9 | 13.5 | 2.5 | 1.2 | ∘ | 5.4 |
| 4 | | | | | | | | | |
| Example | 85 | 75 | 6.75 | 7.1 | 13.5 | 0.9 | 1.6 | ∘ | 15 |
| 5 | | | | | | | | | |
| Example | 85 | 70 | 6.75 | 7.5 | 13.5 | 0.333 | 1.7 | ∘ | 40.5 |
| 6 | | | | | | | | | |

### Examples 7 to 11

The amount of supply of SiH₄ at the time of forming the first layer 51 and at the time of forming the second layer 52 in step 1 was fixed to 2500 sccm and 2875 sccm respectively. In addition, the thickness (height h2 of the lower side plane portion 22) of the first layer 51 which is a lower layer of the first insulating material layer 2a was fixed to 100 nm and the thickness (height h1 of the upper side plane portion 21) of the second layer 52 which is an upper layer thereof was changed. The electron-emitting device was manufactured in the same manner as in the examples 1 to 3 except the above, and the same items except the resistance ratio were measured. The thickness of the first layer 51 and the thickness of the second layer 52 are shown in Table 5. The measured results are shown in Table 6. Note that the emission efficiency ratio is a ratio assuming the electron emission efficiency of a comparative example 1 (described later) as 1.

TABLE 5

Thickness (nm)

| | First layer | Second layer |
|---|---|---|
| Example 7 | 100 | 60 |
| Example 8 | 100 | 50 |
| Example 9 | 100 | 40 |
| Example 10 | 100 | 20 |
| Example 11 | 100 | 10 |

TABLE 6

| | Inclination | | Mo density | | Resistance | | | |
|---|---|---|---|---|---|---|---|---|
| | angle (degrees) | | (g/cm³) | | value (KΩ) | | Emission | Discharge |
| | Lower | Upper | Lower | Upper | Lower | Upper | efficiency | resistant |
| | portion | portion | portion | portion | portion | portion | ratio | performance |
| Example | 90 | 80 | 6.15 | 6.8 | 133.3 | 3.2 | 1.2 | ∘ |
| 7 | | | | | | | | |
| Example | 90 | 80 | 6.15 | 6.9 | 133.3 | 2.667 | 1.4 | ∘ |
| 8 | | | | | | | | |
| Example | 90 | 80 | 6.15 | 7.2 | 133.3 | 2.133 | 1.3 | ∘ |
| 9 | | | | | | | | |
| Example | 90 | 80 | 6.15 | 7.4 | 133.3 | 1.067 | 1.2 | x |
| 10 | | | | | | | | |
| Example | 90 | 80 | 6.15 | 7.8 | 133.3 | 0.533 | 1.1 | ∘ |
| 11 | | | | | | | | |

### Comparative Examples 1 to 4

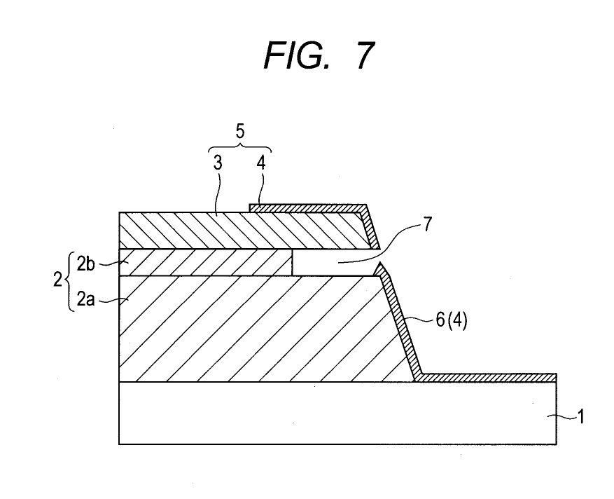

The amount of supply of SiH₄ at the time of forming the first insulating material layer in step 1 was as shown in Table 7 and the electron-emitting device was manufactured in the same manner as in the examples 1 to 3 except that film formation was performed at consecutive one time. The dry etching in step 6 was performed under a constant condition and the first insulating material layer was formed at one film formation under the constant condition. Accordingly, as illustrated in FIG. 7, the entire side plane 20 of the step-shape forming member 2 of the obtained electron-emitting device had the inclined plane with substantially the same inclination and thus had no upper portion or lower portion as opposed to the present invention having an upper portion and a lower portion. The inclination angle θ in the comparative examples 1 to 4 is an angle of the side plane 20 to the surface of the substrate 1. In addition, the Mo density and the resistance value in the cathode 6 formed on the side plane 20 were approximately uniform as a whole. The results of measuring the same items as in the example 1 are shown in Table 7. Note that the emission efficiency ratio is a ratio assuming the electron emission efficiency of a comparative example 1 as 1.

TABLE 7

| | Amount of supply of SiH₄ (sccm) |
|---|---|
| Comparative example 1 | 2500 |
| Comparative example 2 | 2875 |
| Comparative example 3 | 3250 |
| Comparative example 4 | 3625 |

TABLE 8

| | Inclination | Mo | Resistance | Emission | Discharge |
|---|---|---|---|---|---|
| | angle | density | value | efficiency | resistant |
| | (degrees) | (g/cm³) | (KΩ) | ratio | performance |
| Comparative | 90 | 6.1 | 200 | 1 | ◯ |
| example 1 | | | | | |
| Comparative | 80 | 6.6 | 8 | 1.4 | ◯ |
| example 2 | | | | | |
| Comparative | 70 | 6.9 | 1 | 1.7 | X |
| example 3 | | | | | |
| Comparative | 60 | 7.2 | 0.5 | 2 | X |
| example 4 | | | | | |

### Example 12

The electron-emitting device configured as illustrated in FIGS. 1A to 1C was manufactured. The electron-emitting device was manufactured according to the procedure illustrated in FIGS. 6A to 6G. The following description will focus mainly on the steps different from those in the examples 1 to 3.

(Step 1)

A blue plate glass was used as the substrate 1 and was sufficiently cleaned. Then, by means of the CVD technique, the first insulating material layer 2a was formed by depositing an Si₃N₄ film with a thickness of 150 nm at one film formation without changing the condition (see FIG. 6A).

(Step 2) to (Step 3)

The same operation as in the examples 1 to 3 was performed.

(Step 4)

Subsequently, the patterned resistor pattern 53 was used as a mask to dry etch the first insulating material layer 2a, the second insulating material layer 2b, and the first conductive material layer 3 using each of the CF₄, Ar, and SF₆ gases (see FIG. 6E). At this time, the dry etching condition was such that CF₄, Ar, and SF₆ gases were used until the thickness of the second insulating material layer 2a reached 50 nm and the gas flow rate was CF₄/Ar/SF₆=700 sccm/800 sccm/100 sccm. Meanwhile, when the remaining portion was etched, CF₄ and Ar gases were used and the gas flow rate was CF₄/Ar=800 sccm/800 sccm. As a result, from the difference in etching condition and gas type, the two inclinations each with a different angle were formed on the side plane 20 of the step-shape forming member 2 which is the side plane of the first insulating material layer 2a. The sectional shapes were confirmed and measured by a scanning electron microscope. As a result, the inclination angle θ1 of the upper side plane portion 21 was 50 degrees, and the inclination angle θ2 of the lower side plane portion 22 was 90 degrees. The height h1 of the upper side plane portion 21 was 50 nm, and the height h2 of the lower side plane portion 22 was 100 nm.

(Step 5) to (Step 6)

The same operation as in the examples 1 to 3 was performed.

Thus, it was also confirmed by the procedure illustrated in FIGS. 6A to 6G that the electron-emitting device was manufactured in which the cathode 6 was disposed on the side plane 20 of the step-shape forming member 2 having the upper side plane portion 21 and the lower side plane portion 22.

### Example 13

The electron-emitting device manufactured by the procedure of the example 2 was used to manufacture the image display apparatus illustrated in FIG. 4.

First, as an X-direction wiring 45 with a width of 320 μm, a Y-direction wiring 46 with a width of 25 μm, and a pixel with a size of 210 μm×630 μm, the electron-emitting devices 44 each with a size of 320×240 were arranged in matrix on the substrate 1.

Then, the face plate 42 was disposed on the rear plate 46 at a distance of 2 mm above the substrate 1 with the frame body 43 sandwiched therebetween and the inside thereof was sealed in vacuum to form an air-tight container. A plate-like spacer 40 with an X-direction length of 64 mm and a Y-direction length of 200 μm was interposed between the rear plate 46 and the face plate 42 to form an atmosphere-resistant structure. Actually, five spacers 40 were used. Inside the space surrounded by the rear plate 46, the face plate 42, and the frame body 43, a getter (unillustrated) was disposed to maintain the high vacuum of the space. Indium was used to join the rear plate 46 and the frame body 43; and the frame body 43 and the face plate 42.

Then, the electron-emitting device 44 was driven while applying an information signal to the X-direction wiring 45 and applying a scan signal to the Y-direction wiring 46. +6 V pulse voltage was used as the information signal, and −10 V pulse voltage was used as the scan signal. When 6 kV voltage was applied to the anode 49 to cause an emission electron to collide with the light emitting member to be excited and emit light to display an image, a bright image with a small intensity difference was displayed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-137888, filed Jun. 17, 2010, which is hereby incorporated by reference herein in its entirety.

What is claimed is:

1. An electron-emitting device comprising:
a step-shape forming member having upper and side planes and placed on a substrate;
a gate placed on the upper plane of the step-shape forming member;
a concave portion formed at the side plane of the step-shape forming member just under the gate; and
a cathode placed on the side plane of on the step-shape forming member and having an upper edge at which a protruding portion is formed to protrude in a direction from a lower edge toward the upper edge, wherein
an inclination angle of an upper portion of the side plane of the step-shape forming member formed from a lower edge of the concave portion to a middle portion in height direction of the step-shape forming member is not larger than an inclination angle of a lower portion of the side plane of the step-shape forming member formed from the middle portion to a lower end portion of the step-shape forming member, and
an electric resistance of an upper portion of the cathode along the upper portion of the side plane is not larger than an electric resistance of a lower portion of the cathode along the lower portion of the side plane.

2. The electron-emitting device according to claim 1, wherein
the inclination angle of the lower portion of the side plane is larger by 10 degree than the inclination angle of the upper portion of the side plane of the step-shape forming member.

3. The electron-emitting device according to claim 1, wherein
the electric resistance of the lower portion of the cathode is larger by 15 times or more than the electric resistance of the upper portion of the cathode.

4. The electron-emitting device according to claim 1, wherein
the inclination angle of the lower portion of the side plane is within a range of 70 to 90 degrees.

5. The electron-emitting device according to claim 1, wherein
a thickness of the lower portion of the step-shape forming member is larger than a thickness of the higher portion of the step-shape forming member.

6. An image display apparatus comprising:
a rear plate on which the cathode of the electron-emitting device according to claim 1 is connected through the lower portion of the cathode to a wiring; and
a face plate having an anode disposed in opposition to the protruding portion of the cathode sandwiching the gate between the face plate and the cathode, and a light emitting member emitting a light responsive to an irradiation with an electron, wherein
the rear plate and face plate are arranged in opposition to each other forming a gap therebetween.

7. A method of manufacturing an electron-emitting device comprising steps of:
etching a stacked layer structure formed by successively stacking, on a substrate, a first insulating material, a second insulating material and a first electroconductive material, to form a step-shape forming member having upper and side planes and having at the upper plane a layer of the first electroconductive material;
further etching a layer of the second insulating material to form a concave portion at the side plane of the step-shape forming member just under the layer of the first electroconductive material; and
thereafter, bonding a second electroconductive material to form a cathode placed on the side plane of on the step-shape forming member and having an upper edge at which a protruding portion is formed to protrude in a direction from a lower edge toward the upper edge, and to form a gate including the layer of the first electroconductive material alone or including the layer of the first electroconductive material and the layer of the second electroconductive material stacked on the layer of the first electroconductive material, wherein
the method further comprises step of:
forming, at a plurality times, the layer of the first insulating material, and wherein
during the step of etching the stacked layer structure, an etching rate is set such that an etching rate of the lower portion of the layer of the first insulation material is smaller than an etching rate of the upper portion of the layer of the first insulation material, such that an inclination angle of an upper portion of the side plane of the step-shape forming member formed from a lower edge of the concave portion to a middle portion in height direction of the step-shape forming member is not larger than an inclination angle of a lower portion of the side plane of the step-shape forming member formed from the middle portion to a lower end portion of the step-shape forming member, and
the second electroconductive material is supplied from a direction perpendicular to a surface of the substrate to be deposited thereon.

8. A method of manufacturing an electron-emitting device comprising steps of:
etching a stacked layer structure formed by successively stacking, on a substrate, a first insulating material, a second insulating material and a first electroconductive material, to form a step-shape forming member having upper and side planes and having at the upper plane a layer of the first electroconductive material;
further etching a layer of the second insulating material to form a concave portion at the side plane of the step-shape forming member just under the layer of the first electroconductive material; and
thereafter, bonding a second electroconductive material to form a cathode placed on the side plane of on the step-shape forming member and having an upper edge at which a protruding portion is formed to protrude in a direction from a lower edge toward the upper edge, and to form a gate including the layer of the first electroconductive material alone or including the layer of the first electroconductive material and the layer of the second electroconductive material stacked on the layer of the first electroconductive material, wherein
the step of etching the stacked layer structure is performed in a plurality of times in a different conditions, such that an inclination angle of an upper portion of the side plane of the step-shape forming member formed from a lower edge of the concave portion to a middle portion in height direction of the step-shape forming member is not larger than an inclination angle of a lower portion of the side plane of the step-shape forming member formed from the middle portion to a lower end portion of the step-shape forming member, and
the second electroconductive material is supplied from a direction perpendicular to a surface of the substrate to be deposited thereon.

9. The method according to claim 7, wherein
the inclination angle of the lower portion of the side plane is larger by 10 degree than the inclination angle of the upper portion of the side plane of the step-shape forming member.

10. The method according to claim 7, wherein
the inclination angle of the lower portion of the side plane is within a range of 70 to 90 degrees.

11. The method according to claim 7, wherein
a thickness of the lower portion of the step-shape forming member is larger than a thickness of the higher portion of the step-shape forming member.

12. A method of manufacturing an image display apparatus comprising steps of:
preparing a rear plate on which the cathode of the electron-emitting device according to claim 7 is connected through the lower portion of the cathode to a wiring;
preparing a face plate having an anode disposed in opposition to the protruding portion of the cathode sandwiching the gate between the face plate and the cathode, and a light emitting member emitting a light responsive to an irradiation with an electron; and
arranging the rear plate and face plate are arranged in opposition to each other to form a gap therebetween.
